(19) United States
(12) Patent Application Publication
(10) Pub. No.: US 2026/0237931 A1
(43) Pub. Date: Aug. 13, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Risa ITO, Mie (JP)

(21) Appl. No.: 19/470,814

(22) PCT Filed: Mar. 22, 2024
(86) PCT No.: PCT/JP2024/011383

§ 371 Date: Sep. 30, 2025

(30) Foreign Application Priority Data
Apr. 5, 2023 (JP) 2023-061297

(51) Int. Cl. H01R 13/422; H01R 24/38

(52) U.S. Cl. CPC H01R 13/422; H01R 24/38

(57) ABSTRACT

The purpose of the present invention is to regulate rotation of a terminal housed in a terminal-housing component. This connector comprises: a terminal with which a pin-shaped mating terminal is connected by insertion, and which includes a cylindrical base part and a plurality of elastic pieces extending from one end of the cylindrical base part; and a terminal-housing component having a housing space for housing at least a part of the terminal. The cylindrical base part has a slit positioned between the plurality of elastic pieces in the circumferential direction of the cylindrical base part. The slit has a pair of side surfaces facing each other in the circumferential direction of the cylindrical base part. The terminal-housing component has a rotation-preventing protrusion that projects on the housing space side and is positioned between the pair of side surfaces by fitting in the slit.

### TECHNICAL FIELD

The present disclosure relates to a connector.

### BACKGROUND

Patent Document 1 discloses a coaxial connector provided with a lower contact, to which a connection pin is inserted and connected. In a technique disclosed in Patent Document 1, the lower contact is surrounded by a lower insulator and the outer periphery of the lower insulator is surrounded by an electrically conductive external shell.

### PRIOR ART DOCUMENT

Patent Document

Patent Document 1: JP 2020-092313 A

### SUMMARY OF THE INVENTION

### Problems to be Solved

From the perspective of suppressing the deformation of the lower contact in the lower insulator, it is desired to restrict the rotation of the lower contact.

Accordingly, the present disclosure aims to restrict the rotation of a terminal accommodated in a terminal accommodating component.

### Means to Solve the Problem

The present disclosure is directed to a connector with a terminal, a pin-like mating terminal being inserted and connected to the terminal, the terminal including a tubular base portion and a plurality of resilient pieces extending from one end of the tubular base portion, and a terminal accommodating component including an accommodation space for accommodating at least a part of the terminal, the tubular base portion including a slit located between the plurality of resilient pieces in a circumferential direction of the tubular base portion, the slit having a pair of side surfaces facing each other in the circumferential direction of the tubular base portion, and the terminal accommodating component including a rotation stop protrusion projecting toward the accommodation space, the rotation stop protrusion being fit in the slit to be located between the pair of side surfaces.

### Effect of the Invention

According to the present disclosure, the rotation of a terminal accommodated in a terminal accommodating component is restricted.

### BRIEF DESCRIPTION OF THE DRAWINGS

FIG. 1 is a perspective view showing a device provided with a relay coaxial connector according to an embodiment.

FIG. 2 is a section along II-II of FIG. 1.

FIG. 3 is a section of the relay coaxial connector in the same cross-section as in FIG. 2.

FIG. 4 is a section of the relay coaxial connector when viewed from a side opposite to the section of FIG. 2.

FIG. 5 is a section along V-V of FIG. 3.

FIG. 6 is an exploded perspective view showing the relay coaxial connector.

FIG. 7 is a partial exploded perspective view showing the relay coaxial connector.

FIG. 8 is a partial exploded perspective view showing the relay coaxial connector.

FIG. 9 is a section along IX-IX of FIG. 5.

FIG. 10 is a section along X-X of FIG. 3.

FIG. 11 is a section of a relay coaxial connector according to a modification.

### DETAILED DESCRIPTION TO EXECUTE THE INVENTION

### Description of Embodiments of Present Disclosure

First, embodiments of the present disclosure are listed and described.

The connector of the present disclosure is as follows.
(1) The connector of the present disclosure is provided with a terminal, a pin-like mating terminal being inserted and connected to the terminal, the terminal including a tubular base portion and a plurality of resilient pieces extending from one end of the tubular base portion, and a terminal accommodating component including an accommodation space for accommodating at least a part of the terminal, the tubular base portion including a slit located between the plurality of resilient pieces in a circumferential direction of the tubular base portion, the slit having a pair of side surfaces facing each other in the circumferential direction of the tubular base portion, and the terminal accommodating component including a rotation stop protrusion projecting toward the accommodation space, the rotation stop protrusion being fit in the slit to be located between the pair of side surfaces.

According to this connector, the rotation stop protrusion is fit in the slit of the tubular base portion with at least a part of the terminal accommodated in the accommodation space of the terminal accommodating component. By locating the rotation stop protrusion between the pair of side surfaces, the rotation of the terminal is restricted.
(2) In the connector of (1), a width of the slit may be smaller than a width of a gap between the plurality of resilient pieces in a direction along the circumferential direction of the tubular base portion.

In this case, the slit and the rotation stop protrusion fit in the slit hardly affect the resilient deformation of the plurality of resilient pieces.
(3) In the connector of (1) or (2), the tubular base portion may have a front stop surface located between the plurality of resilient pieces and at a position different from the slit in the circumferential direction of the tubular base portion, the front stop surface may be facing toward an extension side of each of the plurality of resilient pieces, and the terminal accommodating component may include a front stop protrusion projecting toward the accommodation space and facing the front stop surface.

In this case, a movement of the terminal to a tip side is restricted by the contact of the front stop protrusion with the front stop surface.
(4) In the connector of (3), a width of the front stop protrusion may be larger than a width of the rotation stop protrusion in a direction along the circumferential direction of the tubular base portion.

In this way, the strength of the front stop protrusion for restricting a movement of the terminal to the tip side can be increased.
(5) In the connector of (3) or (4), the rotation stop protrusion may be facing a back side surface of the slit across a gap on a side opposite to the extension side of each of the plurality of resilient pieces.

In this way, a force for moving the terminal to the tip side is received by the front stop protrusion. Thus, a force applied to the rotation stop protrusion can be reduced and the rotation stop protrusion can be made smaller. Since the slit can be narrowed, the strength of the tubular base portion can be enhanced.
(6) In the connector of any one of (3) to (5), a width of the front stop protrusion may be smaller than a width of a gap between the plurality of resilient pieces in a direction along the circumferential direction of the tubular base portion.

In this way, the resiliently deformed resilient pieces hardly interfere with the front stop protrusion.
(7) In the connector of any one of (1) to (6), the terminal accommodating component may include a head portion for collectively covering tip parts of the plurality of respective resilient pieces, and a part of the head portion may be inserted between the plurality of resilient pieces in a direction along the circumferential direction of the tubular base portion.

In this case, since a part of the head portion of the terminal accommodating component is inserted between the plurality of resilient pieces in the direction along the circumferential direction of the tubular base portion, the head portion can be brought as close to the resilient pieces as possible. In this way, the resilient pieces are easily protected.
(8) In the connector of (7), the pair of side surfaces may contact the rotation stop protrusion to restrict rotation of the terminal within such a range as to avoid contact of any one of the plurality of resilient pieces and the head portion.

In this way, the deformation of the resilient pieces due to the contact of the plurality of resilient pieces and the head portion is suppressed.
(9) In the connector of any one of (1) to (8), an end part of the rotation stop protrusion on an opposite side in an extension direction of each of the plurality of resilient pieces may be a guiding end part narrowed toward a tip.

In this way, the rotation stop protrusion is easily fit into the slit.
(10) In the connector of any one of (1) to (9), an outer conductor may be further provided which surrounds the terminal accommodating component, and the terminal and the outer conductor may be coaxially arranged.

In this way, the connector can be suitably utilized as a coaxial connector. In this case, the terminal accommodating component can be utilized as a dielectric. Even if a distance between the terminal accommodating component and an inner conductor is reduced to increase an arrangement space for the dielectric, the resilient pieces and the terminal accommodating component hardly contact each other and the deformation of the resilient pieces is suppressed since the rotation of the terminal is restricted.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

Hereinafter, a connector according to an embodiment is described. In this embodiment, an example in which the connector is a coaxial connector is described. Further, an example in which the connector is a relay connector incorporated in a device is described. That is, in this embodiment, an example in which the connector is a relay coaxial connector is described.

Note that it is not essential that the connector is the coaxial connector, incorporated in the device and the relay coaxial connector. For example, the connector may be a connector for accommodating terminals in a housing and a connector in which a plurality of terminals are not coaxially arranged. Further, the connector may be a connector to be mounted on a cable end part or mounted on a board.

### Concerning Overall Configuration of Device

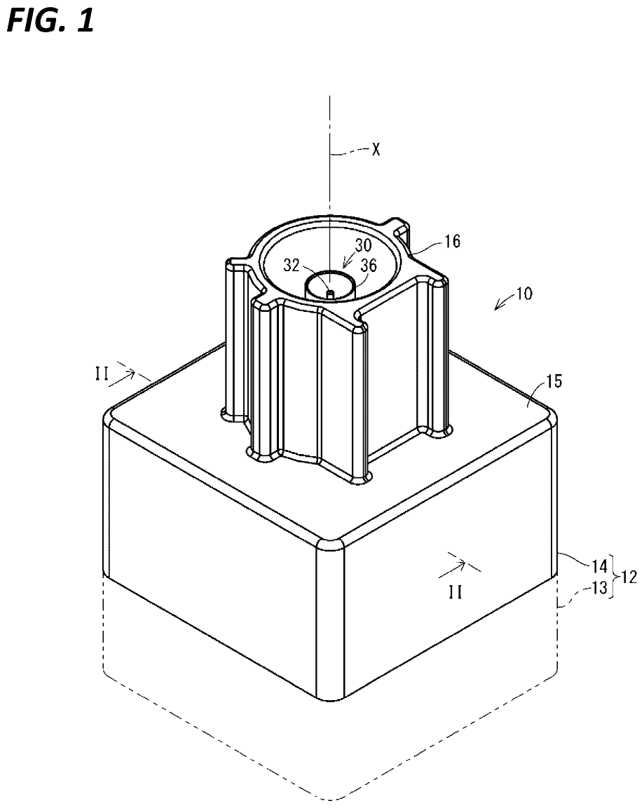

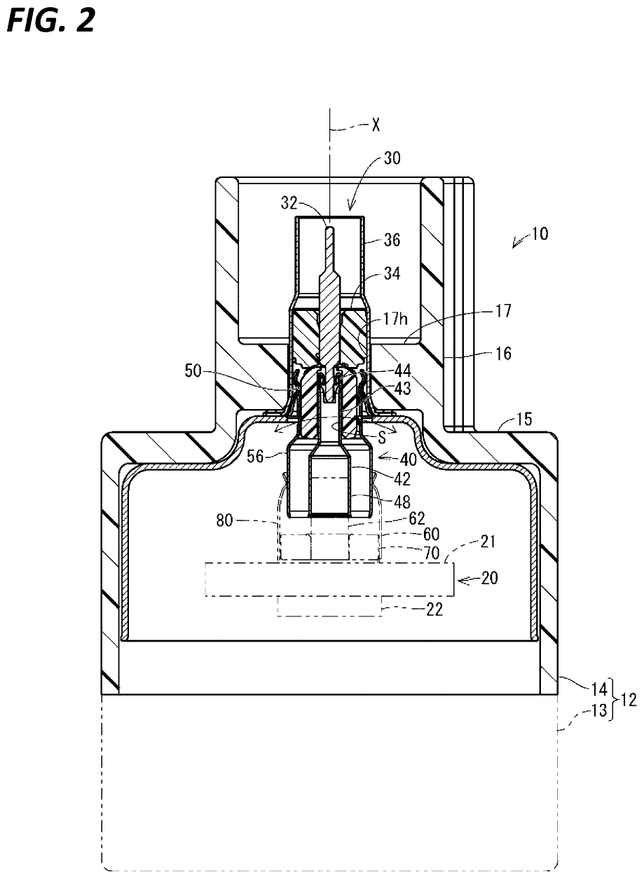

An example of a device 10 provided with a relay coaxial connector 40 is described. FIG. 1 is a perspective view showing the device 10 provided with the relay coaxial connector 40. FIG. 2 is a section along II-II of FIG. 1.

The device 10 is, for example, a camera device. The camera device is, for example, an in-vehicle device. The device 10 may not be a camera device.

The device 10 is provided with a case 12 and an electrical component 20. The electrical component 20 is accommodated in the case 12. The relay coaxial connector 40 is fixed to the electrical component 20.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes an external connection coaxial connector 30.

The external connection coaxial connector 30 is a coaxial connector for connecting the electrical component 20 and an external electrical component. For example, the external connection coaxial connector 30 is a coaxial connector, to which a cable connected to the external electrical component is connected. The cable connected to the external connection coaxial connector 30 is, for example, a coaxial cable.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction along a center axis X of the holding tube portion 16 (axial direction X). In this embodiment, the holding/partitioning portion 17 is formed in the intermediate part in the direction along the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

The external connection coaxial connector 30 is provided with an external connection inner conductor 32, an external connection insulator 34 and an external connection outer conductor 36.

The external connection inner conductor 32 is in the form of an elongated bar and made of an electrically conductive material such as metal. The external connection inner conductor 32 is an example of a pin-like mating inner conductor to be inserted and connected to a movable side inner conductor 42 to be described later. The external connection insulator 34 is formed of a dielectric such as resin and surrounds the external connection inner conductor 32. In this embodiment, the external connection insulator 34 is a dielectric. The external connection outer conductor 36 is made of an electrically conductive material such as metal. The external connection outer conductor 36 is formed into a tubular shape surrounding the external connection insulator 34.

The electrical component 20 is, for example, a mounting board having an electronic component mounted thereon. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

A board side coaxial connector 60 is mounted and fixed on the circuit board 21. The board side coaxial connector 60 is located on a surface of the circuit board 21 opposite to the imaging element 22. The board side coaxial connector 60 projects from the circuit board 21 toward the external connection coaxial connector 30. The board side coaxial connector 60 is, for example, provided with a board side inner conductor 62, a board side insulator 70 and a board side outer conductor 80. The board side inner conductor 62 and the board side outer conductor 80 are, for example, connected to a circuit of the circuit board 21 by soldering or the like. The movable side inner conductor 42 to be described later is connected to the board side inner conductor 62. The board side insulator 70 surrounds the board side inner conductor 62. The board side outer conductor 80 surrounds the board side insulator 70. That is, the board side inner conductor 62, the board side insulator 70 and the board side outer conductor 80 are concentrically arranged in this order from a center toward an outer peripheral side.

The board side coaxial connector 60 and the external connection coaxial connector 30 are connected via the relay coaxial connector 40. The relay coaxial connector 40 is, for example, provided with the movable side inner conductor 42, a movable side insulator 50 and a movable side outer conductor 56. The movable side insulator 50 surrounds the movable side inner conductor 42. A dielectric can be grasped as one type of insulator, and the movable side insulator 50 may be a dielectric. The movable side outer conductor 56 surrounds the movable side insulator 50.

The movable side inner conductor 42 is an example of a terminal including a tubular base portion 43 and a plurality of resilient pieces 44 extending from one end of the tubular base portion 43 and also an example of an inner conductor. The movable side insulator 50 is an example of a terminal accommodating component including an accommodation space S for accommodating at least a part of the movable side inner conductor 42 as the terminal. The movable side outer conductor 56 is an example of an outer conductor surrounding the movable side insulator 50 as the terminal accommodating component. The movable side inner conductor 42 and the movable side outer conductor 56 are coaxially arranged.

The relay coaxial connector 40 is connected to the board side coaxial connector 60 in a state where the board side inner conductor 62 is inserted and connected to the movable side inner conductor 42 and the board side outer conductor 80 is externally fit and connected to the movable side outer conductor 56. In this state, the relay coaxial connector 40 projects further toward the external connection coaxial connector 30 from the board side coaxial connector 60. The external connection inner conductor 32 is inserted and connected to the movable side inner conductor 42 and the movable side outer conductor 56 is inserted and connected to the external connection outer conductor 36, whereby the relay coaxial connector 40 is connected to the external connection coaxial connector 30. In this way, the relay coaxial connector 40 relays and connects the board side coaxial connector 60 and the external connection coaxial connector 30.

In this way, by connecting a cable from outside to the external connection coaxial connector 30, an external electrical component as a connection destination of this cable and the electrical component 20 in the case 12 are electrically connected.

During an assembly operation of this device 10 or in a completed state of this device 10, there is a possibility that the board side coaxial connector 60 and the external connection coaxial connector 30 are shifted from positions facing each other on the same axis. In such a case, the movable side inner conductor 42 is possibly connected in a state inclined with respect to the board side inner conductor 62 and the external connection inner conductor 32. Further, the movable side outer conductor 56 is possibly connected in a state inclined with respect to the board side outer conductor 80 and the external connection outer conductor 36. That is, the relay coaxial connector 40 is possibly connected in a state inclined with respect to the board side coaxial connector 50 and the external connection coaxial connector. In this way, even if the board side coaxial connector 60 and the external connection coaxial connector 30 are shifted from the positions facing each other on the same axis during the assembly operation of this device 10 or in the completed state of this device 10, these position shifts are absorbed by the inclination of the relay coaxial connector 40 with respect to the board side coaxial connector 60 and the external connection coaxial connector.

### Concerning Relay Coaxial Connector

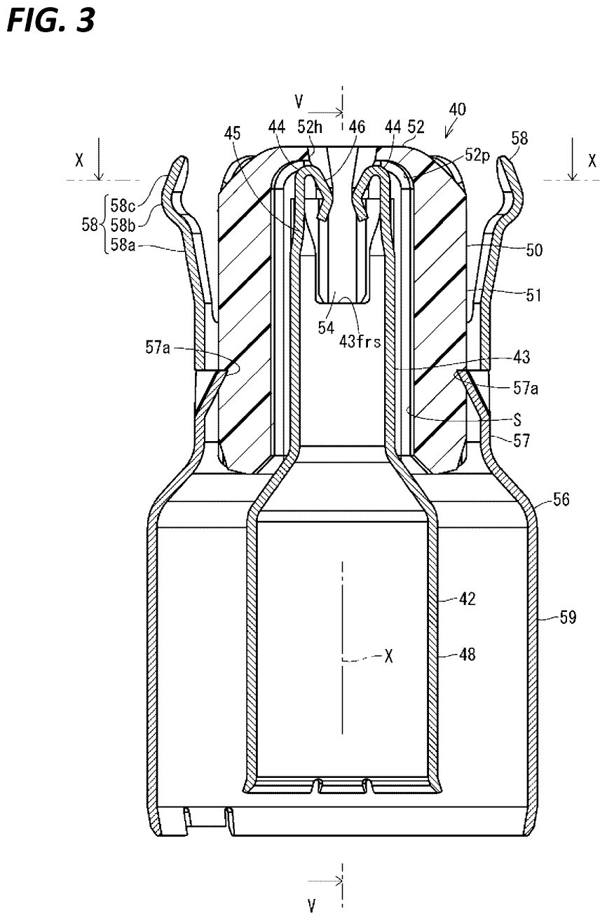

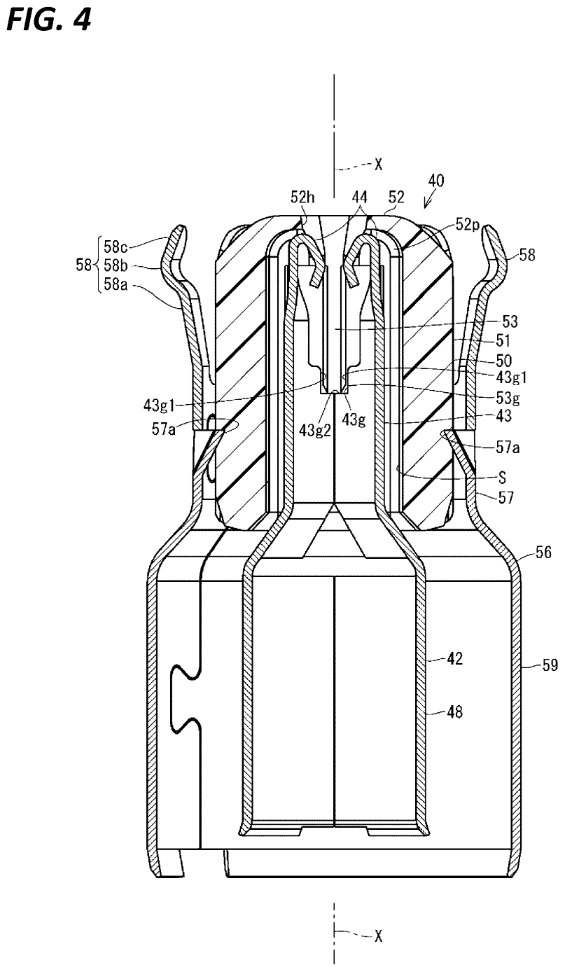

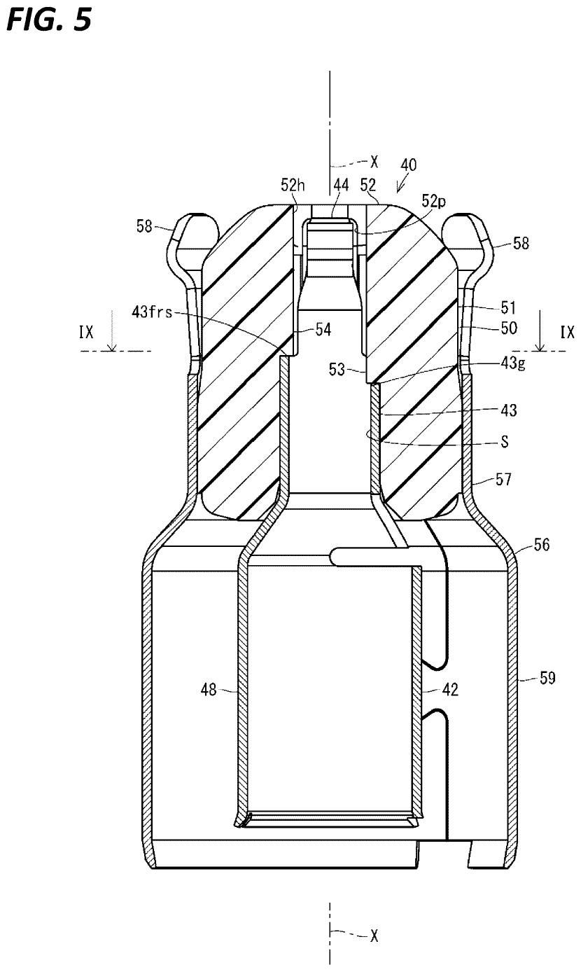

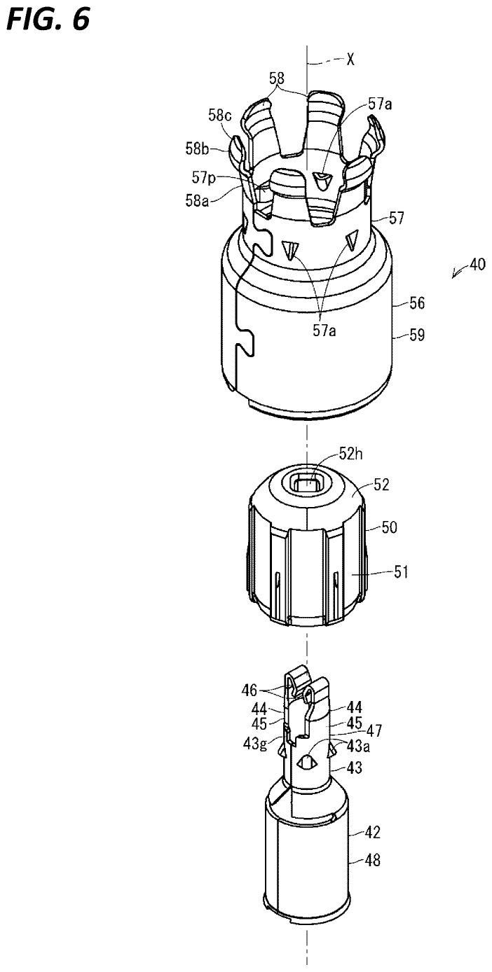

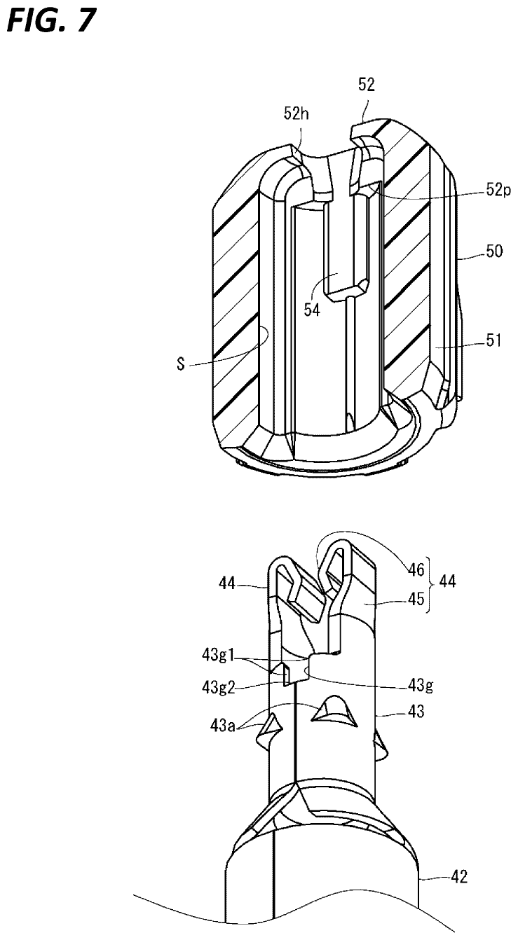

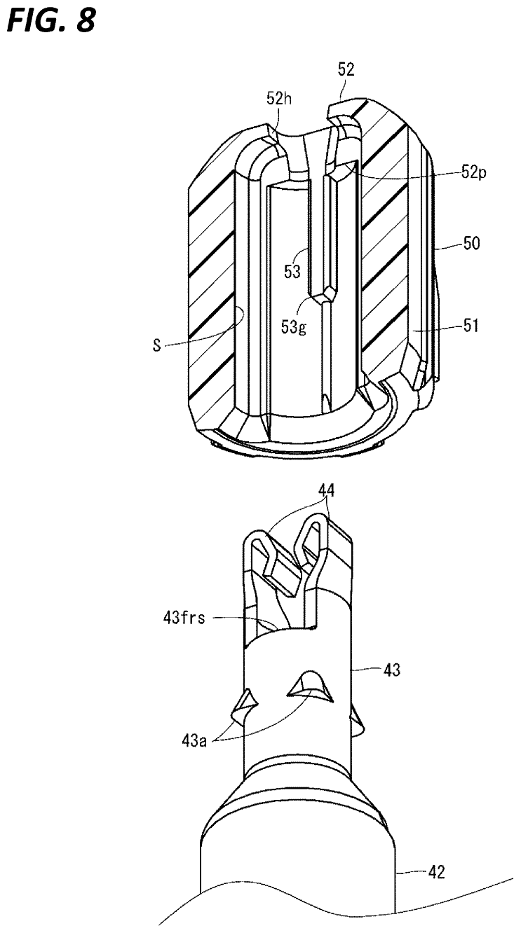

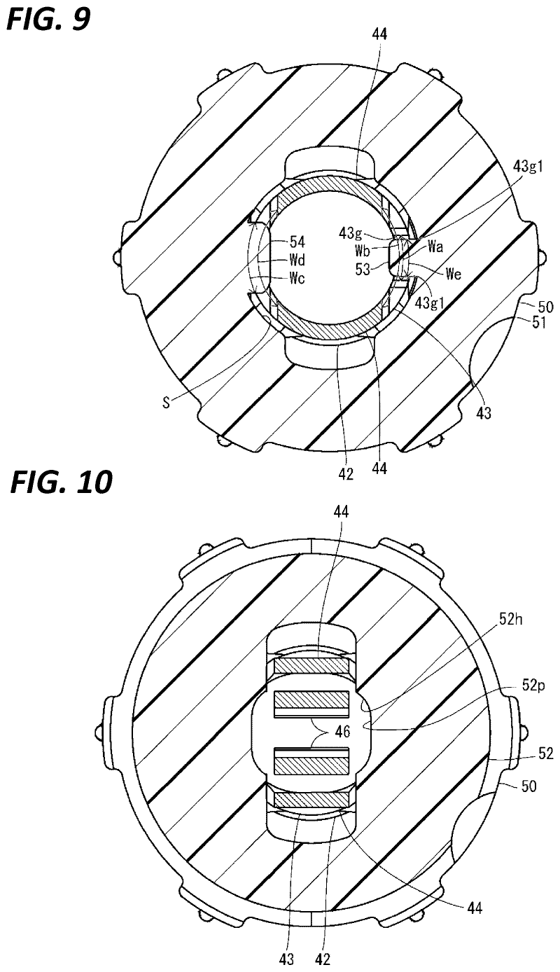

The relay coaxial connector 40 is more specifically described. FIG. 3 is a section of the relay coaxial connector 40 in the same cross-section as in FIG. 2. FIG. 4 is a section of the relay coaxial connector 40 when viewed from a side opposite to the section of FIG. 2. FIG. 5 is a section along V-V of FIG. 3. FIG. 6 is an exploded perspective view showing the relay coaxial connector 40. FIGS. 7 and 8 are partial exploded perspective views showing the relay coaxial connector 40. The movable side insulator 50 is cut along the same plane as in FIG. 3 in FIG. 7, and the movable side insulator 50 is cut along the same plane as in FIG. 4 in FIG. 8. FIG. 9 is a section along IX-IX of FIG. 5, and FIG. 10 is a section along X-X of FIG. 3.

As shown in FIGS. 2 to 10, the relay coaxial connector 40 is provided with the movable side inner conductor 42, the movable side insulator 50 and the movable side outer conductor 56.

The movable side inner conductor 42 is an elongated electrically conductive member. In this embodiment, the movable side inner conductor 42 is formed by press-working a metal plate. More specifically, the movable side inner conductor 42 is provided with the tubular base portion 43, the plurality of resilient pieces 44 and an opposite connecting portion 48.

The tubular base portion 43 is formed into a tubular shape, more specifically a hollow cylindrical shape. One end of the tubular base portion 43 is facing toward the external connection inner conductor 32, and the other end thereof is facing toward the board side inner conductor 62.

Locking protrusions 43a may project on the tubular base portion 43. The locking protrusion 43a partially projects from an outer peripheral part of the tubular base portion 43. The locking protrusion 43a is shaped to gradually increase a projecting dimension from one end toward the other end of the tubular base portion 43. With the tubular base portion 43 inserted in the movable side insulator 50, the locking protrusions 43a are hooked to an inner peripheral part of the movable side insulator 50 and the movable side inner conductor 42 is held not to come out from the movable side insulator 50.

The tubular base portion 43 includes a slit 43g located between the plurality of resilient pieces 44 in a circumferential direction of the tubular base portion 43. The slit 43g is open on one end side, an inner peripheral side and an outer peripheral side of the tubular base portion 43. The slit 43g has a pair of side surfaces 43g1 facing each other in the circumferential direction of the tubular base portion 43. Out of the slit 43g, a surface located on the other end side of the tubular base portion 43 and facing one end of the tubular base portion 43 is a back side surface 43g2.

In this embodiment, a plurality of gaps are present between the plurality of resilient pieces 44, and the slit 43g is present to correspond to some of the plurality of gaps. More specifically, two gaps are present between the two resilient pieces 44, and the slit 43g is provided to correspond to one gap. As described later, a rotation stop protrusion 53 formed on an inner peripheral part of the movable side insulator 50 can be fit into this slit 43g. In this way, the rotation of the movable side inner conductor 42 with respect to the movable side insulator 50 is stopped. Further, a movement of the movable side inner conductor 42 to a tip side with respect to the movable side insulator 50 is restricted.

The plurality of resilient pieces 44 extend from the one end of the tubular base portion 43. Preferably, the plurality of resilient pieces 44 are located at equal intervals around a center axis X of the tubular base portion 43. In this embodiment, the two resilient pieces 44 are facing each around the center axis X of the tubular base portion 43.

Each of the plurality of resilient pieces 44 of includes a resilient piece body 45 and a resilient contact piece 46.

The base end of the resilient piece body 45 is connected to one end of the tubular base portion 43. The resilient piece body 45 extends from the one end of the tubular base portion 43 toward one side in the axial direction X of the tubular base portion 43. The resilient contact piece 46 is folded inward from the tip of the resilient piece body 45 toward the base end of the resilient piece body 45.

The external connection inner conductor 32 is inserted between the two resilient pieces 44 from the tip sides of the two resilient pieces 44. The external connection inner conductor 32 is sandwiched by the two resilient pieces 44, whereby the movable side inner conductor 42 is connected to the external connection inner conductor 32.

Note that it is not essential that the resilient piece includes the folded resilient contact piece, and an inward facing part of a part extending from the tubular base portion toward the one side in the axial direction X may contact the external connection inner conductor 32.

Gaps are present between the resilient piece bodies 45 in the circumferential direction of the tubular base portion 43. Two gaps are present between the two resilient pieces 44 on the one end of the tubular base portion 43.

The slit 43g is formed in a part corresponding to one gap, out of the one end of the tubular base portion 43. A front stop surface 43frs is formed on a part corresponding to the other gap, out of the one end of the tubular base portion 43. The front stop surface 43frs is located between the plurality of resilient pieces 44 and at a position different from the slit 43g in the circumferential direction of the tubular base portion 43. The front stop surface 43frs is a surface facing toward an extension side of the resilient pieces 44. The front stop surface 43frs is preferably orthogonal to the axial direction X.

By the contact of a front stop protrusion 54 of the movable side insulator 50 to be described later with the front stop surface 43frs, the movable side insulator 50 is restricted from moving to the extension side of the resilient pieces 44.

The opposite connecting portion 48 is connected to a side of the tubular base portion 43 opposite to the plurality of resilient pieces 44. The opposite connecting portion 48 is a part to be connected to the board side inner conductor 62. In this embodiment, the opposite connecting portion 48 is a tubular part, more specifically a tubular part thicker than the tubular base portion 43. For example, the board side inner conductor 62 is inserted and connected to the opposite connecting portion 48.

The movable side insulator 50 is made of resin or the like. A dielectric can be grasped as one type of insulator, and the movable side insulator 50 can be grasped as a dielectric. The movable side insulator 50 is, for example, a molded resin component.

The movable side insulator 50 is formed into a tubular shape capable of accommodating at least a part of the movable side inner conductor 42. In this embodiment, the movable side insulator 50 is formed into a hollow cylindrical shape and an accommodation space S is formed inside. The tubular base portion 43 and the plurality of resilient pieces 44 of the movable side inner conductor 42 are accommodated in the accommodation space S. The opposite connecting portion 48 projects outward from the movable side insulator 50.

The movable side insulator 50 includes a tube portion 51 and a head portion 52.

The tube portion 51 is formed into a hollow cylindrical shape. Out of the movable side inner conductor 42, the tubular base portion 43 and parts of the plurality of resilient pieces 44 except the tips are accommodated in the tube portion 51. The rotation stop protrusion 53 can be fit in the slit 43g and located between the pair of side surfaces 43g1. In this way, the rotation of the movable side inner conductor 42 is stopped in the movable side insulator 50.

Further, the tube portion 51 includes the front stop protrusion 54 projecting toward the accommodation space S. The front stop protrusion 54 is arranged to face the front stop surface 43frs. In this way, the movable side inner conductor 42 is restricted from moving to the extension side of the resilient pieces 44 in the tube portion 51.

The head portion 52 is located on an end part on the side of the external connection coaxial connector 30 with respect to the tube portion 51 and collectively covers tip parts of the plurality of resilient pieces 44. The head portion 52 is formed with a hole 52h communicating with the accommodation space S from outside. The hole 52h is thinner than the accommodation space S and so formed that the external connection inner conductor 32 is insertable thereinto. That is, the accommodation space S is narrowed by the head portion 52. The hole 52h is facing gaps between the tips of the plurality of resilient pieces 44 and closes around the tips sides of the plurality of resilient pieces 44. By restricting the position of the external connection inner conductor 32 by the hole 52h, the external connection inner conductor 32 is easily arranged between the plurality of resilient pieces 44.

Out of an inner part of the head portion 52, parts around the hole 52h and located between the plurality of resilient pieces 44 project further inward than other parts. Out of the inner part of the head portion 52, parts covering the tip parts of the plurality of resilient pieces 44 are recessed to be able to allow inward and outward resiliently deformation of the resilient pieces 44. Out of the inner part of the head portion 52, parts 52p located between the plurality of resilient pieces 44 around the hole 52h are inserted between the plurality of resilient pieces 44 in a direction along the circumferential direction of the tubular base portion 43. In this way, the dielectric can be arranged as much as possible in a space around the resilient pieces 44.

Since the parts 52p of the head portion 52 are inserted between the tip parts of the resilient pieces 44, the tip parts of the resilient pieces 44 possibly interfere with the parts 52p if the movable side inner conductor 42 freely rotates. A configuration for stopping the rotation of the movable side inner conductor 42 is described in detail later.

The movable side outer conductor 56 is arranged on an outer peripheral side of the movable side insulator 50. The movable side outer conductor 56 is made of an electrically conductive material such as metal and surrounds the movable side insulator 50. The movable side outer conductor 56 is, for example, formed by press-working a metal plate.

The movable side outer conductor 56 is provided with an outer tubular base portion 57 and outer resilient pieces 58. In this embodiment, the movable side outer conductor 56 is further provided with an outer opposite connecting portion 59.

The outer tubular base portion 57 is formed into such a tubular shape that the movable side insulator 50 can be arranged inside. Locking protrusions 57a may project on the outer tubular base portion 57. The locking protrusion 57a partially projects from an inner peripheral part of the outer tubular base portion 57. The locking protrusion 57a is shaped to gradually reduce a projecting dimension from one end toward the other end of the outer tubular base portion 57. With the movable side insulator 50 inserted in the outer tubular base portion 57, the locking protrusions 57a are hooked to an outer peripheral part of the movable side insulator 50 and the movable side insulator 50 is held not to come out from the outer tubular base portion 57.

The outer tubular base portion 57 may include positioning protrusions 57p partially projecting inward in a circumferential direction (see FIG. 6). The rotation of the outer tubular base portion 57 with respect to the movable side insulator 50 may be stopped by fitting these positioning protrusions 57p into positioning recesses formed in the outer periphery of the movable side insulator 50. By fitting these positioning protrusions 57p into the positioning recesses, a movement of the outer tubular base portion 57 to the other end side with respect to the movable side insulator 50 may be restricted. By externally fitting the outer tubular base portion 57 to the movable side insulator 50, the outer tubular base portion 57 is arranged on the same axis as the tubular base portion 43.

The plurality of outer resilient pieces 58 extend from an opening edge on one end side of the outer tubular base portion 57. The plurality of outer resilient pieces 58 are arranged to surround one end part of the movable side insulator 50.

More specifically, the outer resilient piece 58 includes an inclined portion 58a, a bulging portion 58b and a tip guide portion 58c. The inclined portion 58a, the bulging portion 58b and the tip guide portion 58c are connected in this order from the opening on the one end side of the outer tubular base portion 57 toward one side of a center axis X of the outer tubular base portion 57.

The inclined portion 58a is inclined toward an outer peripheral side from the opening on the one end side of the outer tubular base portion 57 toward the tip of the outer resilient piece 58. The inclined portion 58a can be resiliently deformed in an in-out direction of the outer tubular base portion 57 mainly with a part connected to the outer tubular base portion 57 as a fulcrum.

The bulging portion 58b extends from the tip of the inclined portion 58a toward the one side of the center axis X while forming a curved surface convex outward. A part of the bulging portion 58b projecting furthest toward the outer peripheral side is a part facing outward in a radial direction of the outer tubular base portion 57 and contacting the external connection outer conductor 36.

The tip guide portion 58c is inclined toward an inner peripheral side from the tip of the bulging portion 58b toward the one side of the center axis X.

When the movable side outer conductor 56 is inserted into the external connection outer conductor 36, the tip guide portions 58c contact the opening edge of the external connection outer conductor 36, thereby guiding the outer resilient pieces 58 toward the inner peripheral side of the external connection outer conductor 36. With the movable side outer conductor 56 inserted in the external connection outer conductor 36, the inclined portions 58a are resiliently deformed toward the inner peripheral side. The bulging portions 58b are resiliently pressed against the inner peripheral surface of the external connection outer conductor 36 by resilient forces of the inclined portions 58a to return to an original shape. In this way, the plurality of outer resilient pieces 58 contact the external connection outer conductor 36 from the inner peripheral side and the movable side outer conductor 56 and the external connection outer conductor 36 are connected. The outer opposite connecting portion 59 is inserted and connected to the board side outer conductor 80.

### Concerning Configuration for Restricting Position of Movable Side Inner Conductor in Movable Side Insulator

As described above, the movable side inner conductor 42 is formed with the slit 43g and the movable side insulator 50 is formed with the rotation stop protrusion 53.

As described above, with the tubular base portion 43 inserted in the movable side insulator 50, the locking protrusions 43a are hooked to the inner peripheral part of the movable side insulator 50 and the movable side inner conductor 42 is held not to come out from the movable side insulator 50. In this state, the rotation stop protrusion 53 is inserted into the slit 43g and the rotation of the movable side inner conductor 42 is restricted.

A width between the pair of side surfaces 43g1 of the slit 43g is set to be equal to or larger than a width of the rotation stop protrusion 53.

If the width between the pair of side surfaces 43g1 of the slit 43g is equal to the width of the rotation stop protrusion 53, the rotation of the movable side inner conductor 42 can be stopped. Even if the width between the pair of side surfaces 43g1 of the slit 43g is larger than the width of the rotation stop protrusion 53, the rotation of the movable side inner conductor 42 can be stopped within a certain range in which the rotation stop protrusion 53 contacts the pair of side surfaces 43g1.

Even if the width between the pair of side surfaces 43g1 of the slit 43g is larger than the width of the rotation stop protrusion 53, a width difference is preferably such that the interference of the inner peripheral part of the movable side inner conductor 56 and the resilient pieces 44 can be avoided. For example, the pair of side surfaces 43g1 preferably contact the rotation stop protrusion 53 within such a range as to avoid the contact of any one of the plurality of resilient pieces 44 and the part 52p of the head portion 52, thereby being able to restrict the rotation of the movable side inner conductor 42.

Further, a width Wa of the slit 43g is preferably smaller than a width Wb of the gap between the resilient pieces 44 in a direction along the circumferential direction of the tubular base portion 43 (see FIG. 9). By setting the width Wa of the slit 43g smaller than the width W of the gap between the resilient pieces 44, the strength of the tubular base portion 43 is easily ensured. Further, the resilient pieces 44 are easily stably resiliently deformed at the base ends thereof. Furthermore, since the shape of the tubular base portion 43 can be approximated to a uniform hollow cylindrical shape, a characteristic impedance required for the coaxial connector is easily improved.

An end part of the rotation stop protrusion 53 on an opposite side in an extension direction of the plurality of resilient pieces 44 may be formed into a guiding end part 53g narrowed toward a tip (see FIGS. 4 and 8). When the rotation stop protrusion 53 is inserted into the slit 43g, the guiding end part 53g contacts the opening of the slit 43g to be introduced to the inside of the slit 43g. In this way, the rotation stop protrusion 53 is smoothly inserted into the slit 43g.

The opening of the slit 43g may be formed to be gradually wider toward an outer side. The guiding shape of the guiding end part 53g can be more easily formed by resin molding than by the press working of a metal plate.

Further, as described above, the movable side inner conductor 42 is formed with the front stop surface 43frs. The front stop surface 43frs is located on a side opposite to the slit 43g around the center axis X. Further, the movable side insulator 50 is formed with the front stop protrusion 54. The front stop protrusion 54 is located on a side opposite to the rotation stop protrusion 53 around the center axis X.

As described above, with the tubular base portion 43 inserted in the movable side insulator 50, the locking protrusions 43a are hooked to the inner peripheral part of the movable side insulator 50 and the movable side inner conductor 42 is held not to come out from the movable side insulator 50. In this state, the front stop protrusion 54 faces the front stop surface 43frs. Preferably, the front stop protrusion 54 is in contact with the front stop surface 43frs. A movement of the movable side inner conductor 42 to the extension side of the resilient pieces 44 with respect to the movable side insulator 50 is restricted by the front stop protrusion 54.

A width Wc of the front stop protrusion 54 is preferably smaller than a width Wd of the gap between the resilient pieces 44 in a direction along the circumferential direction of the tubular base portion 43. In this way, when the resilient pieces 44 are resiliently deformed in the in-out direction and in a resiliently deformed state of the resilient pieces 44, the resilient pieces 44 are less likely to interfere with the front stop protrusion 54. Accordingly, when the external connection inner conductor 32 is inserted between the plurality of resilient pieces 44, movements of the resilient pieces 44 are hardly hindered and that inserting operation is easily performed. Further, also in the inserted state of the external connection inner conductor 32, the resilient pieces 44 are hardly hooked to the front stop protrusion 54 and can firmly contact the external connection inner conductor 32.

A relationship of the rotation stop protrusion 53 and the front stop protrusion 54 is described.

In the direction along the circumferential direction of the tubular base portion 43, the width Wc of the front stop protrusion 54 is preferably larger than a width We of the rotation stop protrusion 53. In this way, the strength of the front stop protrusion 54 for restricting a movement of the movable side inner conductor 42 to the tip side can be increased. For example, at the time of assembling the relay coaxial connector 40 and a connector inserting/removing operation and the like, a rotational force and a moving force to moving the movable side inner conductor 42 to the tip side are possibly applied to the movable side inner conductor 42. Such as when the movable side inner conductor 42 is mounted into the movable side insulator 50 and when the connector is removed, a large force for moving the movable side inner conductor 42 to the tip side is possibly applied. By increasing the width Wc of the front stop protrusion 54, a movement of the movable side inner conductor 42 to the tip side can be firmly restricted.

Further, since the gaps are originally formed between the plurality of resilient pieces 44, even if the width of the rotation stop protrusion 53 to be arranged in the gap is increased in such a range that the rotation stop protrusion 53 does not interfere with the resilient pieces 44, this hardly affects the strength of the movable side inner conductor 43. Further, this hardly affects the characteristic impedance of the coaxial connector.

With the front stop protrusion 54 held in contact with the front stop surface 43frs, the rotation stop protrusion 53 may or may not be in contact with the back side surface 43g2 of the slit 43g. In an example shown in FIG. 5, the rotation stop protrusion 53 is in contact with the back side surface 43g2 of the slit 43g with the front stop protrusion 54 held in contact with the front stop surface 43frs.

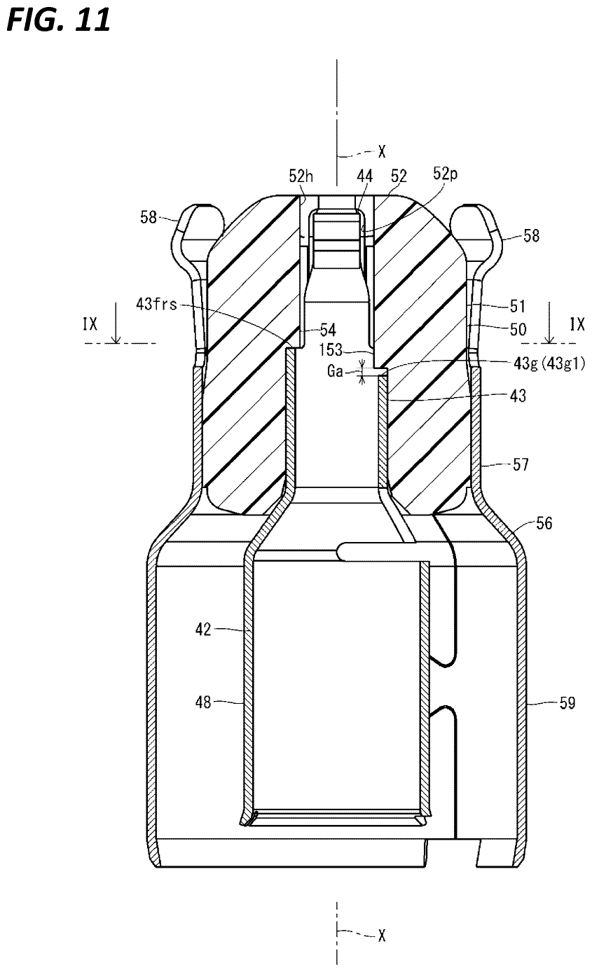

As in a modification shown in FIG. 11, a rotation stop protrusion 153 corresponding to the rotation stop protrusion 53 may face the back side surface 43g2 of the slit 43g across a gap Ga with the front stop protrusion 54 held in contact with the front stop surface 43frs.

In this case, if the front stop protrusion 54 contacts the front stop surface 43frs when the movable side inner conductor 42 is pushed toward the movable side insulator 50, a pushing force hardly acts on the rotation stop protrusion 53. If the rotation stop protrusion 53 is thinner than the front stop protrusion 54, this force applied to the thin rotation stop protrusion 53 can be reduced by receiving this pushing force by the relatively thick front stop protrusion 54.

### Effects, Etc.

According to the relay coaxial connector 40 configured as described above, the rotation stop protrusion 53 is fit into the slit 43g of the tubular base portion 43 with the movable side inner conductor 42 at least partially accommodated in the accommodation space S of the movable side insulator 50. By locating the rotation stop protrusion 53 between the pair of side surfaces 43g1 of the slit 43g, the rotation of the movable side inner conductor 42 is restricted. By restricting the rotation of the movable side inner conductor 42, the positions of the resilient pieces 44 in the movable side insulator 50 are stabilized, the interference of the resilient pieces 44 and the rotation stop protrusion is suppressed and unexpected deformation and the like of the resilient pieces 44 are suppressed.

Further, since the width Wa of the slit 43g is smaller than the width Wb of the gap between the resilient pieces 44, the slit 43g and the rotation stop protrusion 53 fit in the slit 43g hardly affect the resilient deformation of the plurality of resilient pieces 44. Further, in the relay coaxial connector 40, parts including no electrically conductive parts can be reduced and coaxially shaped parts can be increased, and the characteristic impedance is less likely to be affected.

Further, the front stop protrusion 54 different from the rotation stop protrusion 53 is facing the front stop surface 43frs. By the contact of the front stop protrusion 54 with the front stop surface 43frs, a movement of the movable side inner conductor 42 to the tip side is restricted.

Particularly, by setting the width Wc of the front stop protrusion 54 larger than the width We of the rotation stop protrusion 53, a movement of the movable side inner conductor 42 to the tip side can be more reliably restricted by the thick front stop protrusion 54.

For example, it is possible to cause the rotation stop protrusion 153 according to the modification to face the back side surface 43g2 of the slit 43g across a gap. In this case, a force for moving the movable side inner conductor 42 to the tip side is received by the front stop protrusion 54. Thus, the force applied to the rotation stop protrusion 53 can be reduced and the rotation stop protrusion 53 can be made smaller. Since the slit 43g can be narrowed, characteristic impedance performance is less likely to be affected.

Further, by setting the width of the front stop protrusion 54 smaller than the width between the resilient pieces 44, the resiliently deformed resilient pieces 44 can be made less likely to interfere with the front stop protrusion 54. In this way, unexpected deformation and the like of the resilient pieces 44 are suppressed.

Further, the movable side insulator 50 includes the head portion 52 for covering the tip parts of the plurality of resilient pieces 44, and the head portion 52 includes the parts 52p to be inserted between the plurality of resilient pieces 44. In this case, the head portion 52 can be brought as close to the resilient pieces 44 as possible and the resilient pieces 44 are easily protected. Further, dielectric arrangement locations around the resilient pieces 44 can be increased and the characteristic impedance is easily improved.

Further, the pair of side surfaces 43g1 contact the rotation stop protrusion 53 to restrict the rotation of the movable side inner conductor 42 within such a range as to avoid the contact of the resilient pieces 44 and the parts 52p of the head portion 52. In this way, the deformation of the resilient pieces 44 due to the contact of the resilient pieces 44 and the head portion 52 is suppressed.

Further, since the rotation stop protrusion 53 includes the guiding end part 53g, the rotation stop protrusion 53 is easily fit into the slit 43g.

Since the respective components are incorporated into the relay coaxial connector 40 as the coaxial connector, the movable side insulator 50 as the terminal accommodating component is utilized as a dielectric. Even if a distance between the movable side insulator 50 and the movable side inner conductor 42 is reduced to increase an arrangement space for the dielectric, the resilient pieces 44 and the movable side insulator 50 hardly contact each other and the deformation of the resilient pieces 44 is suppressed since the rotation of the movable side inner conductor 42 is restricted.

Note that the respective configurations described in the above embodiment and each modification can be approximately combined without contradicting each other.

### LIST OF REFERENCE NUMERALS

10 device
12 case
13 first case
14 second case
15 bottom portion
16 holding tube portion
17 holding/partitioning portion
17h holding hole
20 electrical component
21 circuit board
22 imaging element
30 external connection coaxial connector
32 external connection inner conductor (mating terminal)
34 external connection insulator
36 external connection outer conductor
40 relay coaxial connector (connector)
42 movable side inner conductor (terminal)
43 tubular base portion
43a locking protrusion
43frs front stop surface
43g slit
43g1 pair of side surfaces
43g2 back side surface
44 resilient piece
45 resilient piece body
46 resilient contact piece
48 opposite connecting portion
50 movable side insulator (terminal accommodating component)
51 tube portion
52 head portion
52h hole
52p head parts inserted between resilient pieces
53, 153 rotation stop protrusion
53g guiding end part
54 front stop protrusion
56 movable side outer conductor (outer conductor)
57 outer tubular base portion
57a locking protrusion
57p positioning protrusion
58 outer resilient piece
58a inclined portion
58b bulging portion
58c tip guide portion
59 outer opposite connecting portion
60 board side coaxial connector
62 board side inner conductor
70 board side insulator
80 board side outer conductor
S accommodation space
Wa width of slit
Wb, Wd width of gap between resilient pieces
Wc width of front stop protrusion
We width of rotation stop protrusion
X axial direction (center) axis

1. A connector, comprising:
a terminal, a pin-like mating terminal being inserted and connected to the terminal, the terminal including a tubular base portion and a plurality of resilient pieces extending from one end of the tubular base portion; and
a terminal accommodating component including an accommodation space for accommodating at least a part of the terminal,
the tubular base portion including a slit located between the plurality of resilient pieces in a circumferential direction of the tubular base portion,
the slit having a pair of side surfaces facing each other in the circumferential direction of the tubular base portion, and
the terminal accommodating component including a rotation stop protrusion projecting toward the accommodation space, the rotation stop protrusion being fit in the slit to be located between the pair of side surfaces.

2. The connector of claim 1, wherein a width of the slit is smaller than a width of a gap between the plurality of resilient pieces in a direction along the circumferential direction of the tubular base portion.

3. The connector of claim 1, wherein:
the tubular base portion has a front stop surface located between the plurality of resilient pieces and at a position different from the slit in the circumferential direction of the tubular base portion,
the front stop surface is facing toward an extension side of each of the plurality of resilient pieces, and
the terminal accommodating component includes a front stop protrusion projecting toward the accommodation space and facing the front stop surface.

4. The connector of claim 3, wherein a width of the front stop protrusion is larger than a width of the rotation stop protrusion in a direction along the circumferential direction of the tubular base portion.

5. The connector of claim 3, wherein the rotation stop protrusion is facing a back side surface of the slit across a gap on a side opposite to the extension side of each of the plurality of resilient pieces.

6. The connector of claim 3, wherein a width of the front stop protrusion is smaller than a width of a gap between the plurality of resilient pieces in a direction along the circumferential direction of the tubular base portion.

7. The connector of claim 1, wherein:
the terminal accommodating component includes a head portion for collectively covering tip parts of the plurality of respective resilient pieces, and
a part of the head portion is inserted between the plurality of resilient pieces in a direction along the circumferential direction of the tubular base portion.

8. The connector of claim 7, wherein the pair of side surfaces contact the rotation stop protrusion to restrict rotation of the terminal within such a range as to avoid contact of any one of the plurality of resilient pieces and the head portion.

9. The connector of claim 1, wherein an end part of the rotation stop protrusion on an opposite side in an extension direction of each of the plurality of resilient pieces is a guiding end part narrowed toward a tip.

10. The connector of claim 1, further comprising an outer conductor surrounding the terminal accommodating component, wherein:
the terminal and the outer conductor are coaxially arranged.
